(19) United States
(12) Patent Application Publication
(10) Pub. No.: US 2016/0290766 A1
(43) Pub. Date: Oct. 6, 2016

(54) GUN MOUNTED CAMERA

(71) Applicants: Akeem Williams, Ft. Walton Beach, FL (US); Robert Gordon, Ft. Walton Beach, FL (US)

(72) Inventors: Akeem Williams, Ft. Walton Beach, FL (US); Robert Gordon, Ft. Walton Beach, FL (US)

(21) Appl. No.: 14/675,995

(22) Filed: Apr. 1, 2015

(51) Int. Cl. F41G 3/26; H04N 7/18

(52) U.S. Cl. CPC F41G 3/2611; H04N 7/181

(57) ABSTRACT

A system for recording gun activity that includes: a mounting bracket; a camera, where camera is attached the mounting bracket and the mounting bracket enables attachment to a gun barrel; a camera lens directed inline with the gun barrel; a lighting mechanism within the camera directed in the line of sight of the camera lens; a microprocessor incorporated into the camera; a battery, where the battery supplies power to the camera; a memory chip, where the memory chip stores images captured by the camera; and a proximity sensor, where the proximity sensor activates the camera lens and lighting mechanism and places the camera in a record mode. The camera may further include a USB port for transmitting data to and from the camera. Preferably, the system also includes a holster, where the holster includes an external battery. The camera may further include charging strips where the charging strips connect to the external battery of the holster.

### BACKGROUND OF THE INVENTION

1. Field of Invention

The present invention relates to a camera that is capable of being mounted onto a gun.

2. Description of Related Art

Law enforcement officers typically carry firearms to assist in conducting their task of enforcing laws. On occasion, law enforcement officers must use their firearm for self-protection and to apprehend criminals. As a result, an officer's actions related to use of the firearm may come in question especially when the use of the fireman results in a death of a suspect. Further more scrutiny has been directed to law enforcement regarding questionable use of service weapons. As a consequence there has been a higher public concern with respect to the monitoring of police activity. Many watchdog groups have insisted upon the need for cameras to be mounted directly on police officers as a means to record police activity. As a consequence, the use of body cameras has been increasingly suggested and implemented in various police departments. One drawback to the body camera is that there is constant recording therefore the use of the body camera may not always be effective in capturing the incident as it unfolds. Further occasionally footage may be lost due to the nature of the police encounter. As a consequence, it would be advantageous to have a further device that may engage with the officer's weapon so that a view is provided of the officer's use of the weapon. Such a device may be triggered as necessary particularly when the officer retrieves his weapon out of his holster.

### SUMMARY OF THE INVENTION

The present invention relates to a system for recording gun activity that includes: a mounting bracket; a camera, where camera is attached the mounting bracket and the mounting bracket enables attachment to a gun barrel; a camera lens directed inline with the gun barrel; a lighting mechanism within the camera directed in the line of sight of the camera lens; a microprocessor incorporated into the camera; a battery, where the battery supplies power to the camera; a memory chip, where the memory chip stores images captured by the camera; and a proximity sensor, where the proximity sensor activates the camera lens and lighting mechanism and places the camera in a record mode. The camera may further include a USB port for transmitting data to and from the camera. Preferably, the system also includes a holster, where the holster includes an external battery. The camera may further include charging strips where the charging strips connect to the external battery of the holster.

### BRIEF DESCRIPTION OF DRAWINGS

FIG. 1 depicts a side view of a camera mounted on a gun barrel in accordance with the present invention.

FIG. 2 depicts a front view of the camera in accordance with the present invention.

FIG. 3 depicts a top view of the camera body in accordance with the present invention.

FIG. 4 depicts a bottom view of the camera body in accordance with the present invention.

FIG. 5 depicts a holster that is used in conjunction with the camera-mounted police weapon according to the present invention.

### DETAILED DESCRIPTION

The present invention relates to a camera that is capable of being mounted directly onto the barrel of a handgun. This camera in accordance with the present invention is contemplated for use with police officers as a further means to record police activity and in particular police activity when the weapon is being used. The present invention firmly attaches to the underside of a barrel of a police weapon. The camera is activated upon the removal of the weapon from a holster. As a consequence, the present invention records activity of the use of the weapon once placed in action with the police officer.

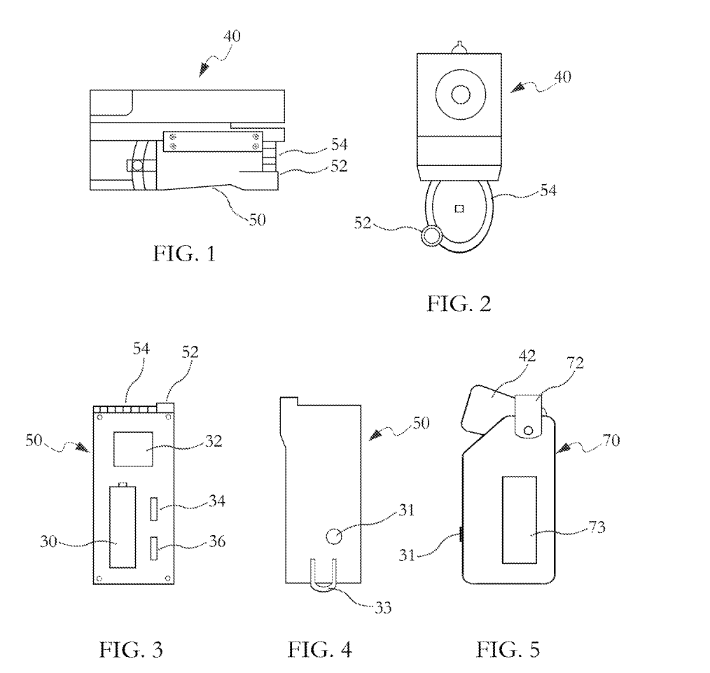

With respect to FIG. 1, a side view of a camera body in accordance with the present invention is depicted. As shown, a camera 50 is attached to the underside of a gun barrel 40. A mounting bracket is provided to mount the camera 50 onto the gun barrel. A camera lens 52 is provided on a front side of the camera 50 along with lighting 54. The lighting 54 provides a beam of light to help in the recording of activity when the gun is in use. FIG. 2 depicts a front view of the gun barrel 40 and camera lens 52. As shown, the camera lens 52 is positioned at a lower point below the lighting 54, which is directed forward to support the view of the camera lens 52.

Further features related to the camera 50 in accordance with the present invention include a microprocessor 32 shown in FIG. 3. The microprocessor 32 helps to record and execute the functions related to the camera lens 52. A battery 30 is provided that powers the camera lens 52, lighting 54 and other features related to the operation of the camera 50. A memory chip 36 is provided along with a USB port 34. The USB port 34 allows for the transfer of data from the camera 52 to an external drive or a computing device such as a laptop or desktop computer.

FIG. 4 provides a bottom view of the camera 50 in accordance with the present invention. This underside includes a proximity sensor 31. The proximity sensor 31 assists in the activation of the camera 50 into the on position. Further shown on the bottom side are charging strips 33. Charging strips 33 connect to an external battery 73 provided on a holster 70 as shown in FIG. 5. This external battery 73 helps to keep the battery 30 in a charged position and ensures that sufficient battery charge is provided for the camera 52. Proximity sensor 31 extends from the holster 70 and as stated activates the camera 52 once the gun 40 is removed from the holster 70. Further a strap 72 is provided that keeps the gun within the holster as a gun butt 42 extends out of the holster 70.

This camera system according to the present invention helps to instantaneously record activity once the weapon is removed and provides additional evidence to prove justified use of the weapon. The device records this footage and stores it in memory and therefore is available for review and down transmittal to a hard drive for analysis. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for recording gun activity comprising:
a. a mounting bracket;
b. a camera, where camera is attached the mounting bracket and the mounting bracket enables attachment to a gun barrel;
c. a camera lens directed inline with the gun barrel;
d. a lighting mechanism within the camera directed in the line of sight of the camera lens;
e. a microprocessor incorporated into the camera;
f. a battery, where the battery supplies power to the camera;
g. a memory chip, where the memory chip stores images captured by the camera; and
h. a proximity sensor, where the proximity sensor activates the camera lens and lighting mechanism and places the camera in a record mode.

2. The system according to the claim 1, further including a USB port installed on the camera for transmitting data to and from the camera.

3. The system according to the claim 1, further including a holster.

4. The system according to claim 3, where the holster includes an external battery.

5. The system according to claim 4, where the camera further includes charging strips, where the charging strips connect to the external battery.
